(19) United States
(12) Patent Application Publication
(10) Pub. No.: US 2024/0399630 A1
(43) Pub. Date: Dec. 5, 2024

(54) METHOD FOR THE MANUFACTURING OF A HEATED INTERIOR CLADDING PART

(71) Applicant: Lisa Dräxlmaier GmbH, Vilsbiburg (DE)

(72) Inventor: Marco REIS, Bodenkirchen (DE)

(73) Assignee: Lisa Dräxlmaier GmbH, Vilsbiburg (DE)

(21) Appl. No.: 18/798,252

(22) Filed: Aug. 8, 2024

Related U.S. Application Data
(63) Continuation of application No. PCT/EP2023/053005, filed on Feb. 7, 2023.

(30) Foreign Application Priority Data
Feb. 14, 2022 (DE) 10 2022 103 362.7

(51) Int. Cl. B29C 44/12; B29K 75/00; B29K 105/04; B29K 655/02; B29K 669/00; B29L 31/30; B60H 1/22

(52) U.S. Cl. CPC B29C 44/1266; B60H 1/2227; B29K 2075/00; B29K 2105/04; B29K 2655/02; B29K 2669/00; B29L 2031/3026

(57) ABSTRACT

A method for the manufacture of an interior cladding part with a visible side and a flat heating element includes arranging of the flat heating element as foam mat in a foaming tool such that the flat heating element abuts with a first flat side, which is facing the visible side of the interior cladding part to be manufactured, against an interior surface of the foaming tool, and introducing a first foam material into the foaming tool on a second flat side, opposite the first flat side, of the flat heating element such that the flat heating element is only back-foamed on the second flat side. The first foam material connects with the carrier element and the flat heating element.

### CROSS-REFERENCE TO RELATED APPLICATIONS

This application is a continuation of International Application No. PCT/EP2023/053005, filed on Feb. 7, 2023, which claims priority to and the benefit of DE 10 2022 103 362.7 filed on Feb. 14, 2022. The disclosure of each of the above referenced applications is incorporated herein by reference.

### FIELD

The present disclosure relates to a method for the manufacturing of an interior cladding part, and use of the interior cladding part manufactured in this manner.

### BACKGROUND

The statements in this section merely provide background information related to the present disclosure and may not constitute prior art.

For example, from DE 10 2014 005 190 A1, interior cladding parts are known that are used, for example, in vehicles as heated armrests, steering wheels, or the like. Such an interior cladding part usually includes at least one foam material layer to be upholstered for an intended purpose. The heating of such an interior cladding part is affected by a usually flat heating element that is comprised of a fleece with heating coils applied thereon.

In practice it has been shown that such heating coils, which at least slightly protrude from the fleece, stand out on the thus provided interior cladding part on the visible side of the interior cladding if no additional constructive measures are taken. One possible constructive measure is the providing of an additional cut foam between the fleece and a decorative material forming the visible side. A disadvantage is the increased process- and material-expense due to the providing of the additional cut foam. The above-mentioned DE 10 2014 005 190 A1 proposes another possibility, namely the foam-encapsulating of the flat heating element with a foam material. However, this can impair the heating performance of the interior cladding part, since the foam-encapsulating of the flat heating element in any case creates an additional foam-material layer on the visible side of the inner cladding part.

### SUMMARY

This section provides a general summary of the disclosure and is not a comprehensive disclosure of its full scope or all of its features.

The present disclosure includes an interior cladding part which in the use of the interior cladding part includes a visible side and a flat heating element for the heating of the visible side. The present disclosure also provides for the use of the interior cladding part manufactured in this manner as an armrest in a vehicle, such as, for example a motor vehicle.

The present disclosure provides, using simple construction, an interior cladding part on whose visible side a heating element stands out at least slightly less and that is heatable.

A method is proposed for the manufacturing of an interior cladding part with a visible side and a flat heating element. The interior cladding part manufactured with the method or possibly with a subsequent process can be suitable, for example, as an armrest on a door cladding, a central console, or similar. In this configuration the interior cladding part can also be referred to as a heatable interior cladding part. The method provides the steps described below that can be carried out in the sequence specified or in a sequence deviating therefrom. A carrier element is provided. In addition, the flat heating element is disposed as a foam mat or heating mat in a foaming tool such that the flat heating element abuts with a first flat side, which is facing the visible side of the interior cladding part to be manufactured, against an inner surface of the foaming tool. Furthermore, a first foam material is introduced into the foaming tool on a second flat side, opposite the first flat side, of the flat heating element such that the flat heating element is back-foamed only on the second flat side. In addition, it is provided that the first foam material connects with the carrier element and the flat heating element.

In other words, the flat heating element is provided as foam mat or heating mat, and used in the interior cladding part to be manufactured, and also only back-foamed from one side, but not foam-encapsulated on both sides, since the flat heating element abuts against the inner surface of the foaming tool. Thus no or at least hardly any foam material reaches the first flat side of the flat heating element, and this first flat side of the heating element remains substantially clear or not wetted. Accordingly compared to the conventional methods, it is avoided that a cut foam or another foam-material layer acts as an insulator between the flat heating element and the visible surface and reduces the heating performance. In particular, in comparison to the use of a fleece with heating coils disposed therein, the foam mat in the proposed method stands out less or not at all on the visible surface, since in contrast to the fleece the foam mat has a lesser hardness, for example, compression hardness, or is softer. In addition, the foam mat makes possible a greater softness and can therefore yield to a greater degree, which increases or improves the material appearance of the interior cladding part.

In this context the “foam mat,” which can also be referred to as “foamed mat,” can be understood as a mat-shaped element made of a suitable foam material that has a greater softness or lesser hardness than, in particular, a fleece material. In addition, the “foam mat” can be understood as a mat-shaped element with two opposing, at least substantially flat surfaces without elevation, i.e., with integrated instead of superimposed heating coils.

Here the “carrier element” can be understood to be a structure-conferring element in the shape of, for example, a door cladding or a part thereof, in particular of an armrest, a central console or a part thereof, in particular a central armrest, or similar. The carrier element can be produced from a metal material, however, in one example it can be produced from a plastic material, such as, for example, a polycarbonate (PC) or acrylonitrile-butadiene-styrene copolymer (ABS). The carrier element can be manufactured and provided, for example, using an injection-molding method. The carrier element can also be prefabricated.

According to a further development of the method, the flat heating element can be laminated with a decorative material such that the first flat side of the flat heating element abuts directly against the decorative material. Here the decorative material forms the visible side of the interior cladding part. The decorative material can be, for example, a leather, artificial leather, or similar. The laminating can be affected, for example, by press laminating, which represents an at least fully-automatable-as-possible manufacturing process. This makes possible a particularly efficient manufacturing of the interior cladding part, wherein a further foam-material layer can be spared by foam-encapsulating of the flat heating element, or by the providing of an additional cut foam.

In one further development of the method, the flat heating element can be provided as foam mat with heating elements, for example, heating coils, embedded in a second foam material. In one example, a plurality of heating elements, i.e., at least two or more, is provided. The heating elements can be supplied with electricity by an electrical line, a supply line, and thus cause a heating effect. In this context “embedded” can be understood to mean that the heating elements are disposed inside the foam material of the foam mat such that at least the first flat side or both flat sides of the foam mat are at least substantially flat or level, i.e., have no elevations with respect to the heating elements. It is also possible that the heating elements are embedded in a sandwich-like manner in the foam material, i.e., do not lie open to the first flat side of the flat heating element but rather are covered by the foam material, in one example, the same foam material. A standing out of the heating elements on the visible side of the interior cladding part can thus be avoided in a constructively simple manner.

According to one further development of the method, the flat heating element can be provided such that the heating elements are disposed flush with or recessed with respect to the first flat side. In other words, the heating elements of the foam mat can be recessed deep enough in the foam material of the flat heating element with respect to the first flat side that they reach at most to a plane defined by the first flat side, but do not protruded past this, in order to thus avoid an elevation of the heating elements on the first flat side. A standing out of the heating elements on the visible side of the interior cladding part can thereby be avoided in a constructively simple manner.

In one further development of the method, the first foam material applied onto the second flat surface of the flat heating element can be a polyurethane foam, PUR foam. It has been shown that the PUR foam connects particularly well with the second foam material of the foam mat. Here the first foam material can be introduced in the so-called one-shot method, in which all components are mixed together without solvent, whereby a particularly efficient manufacturing is achieved.

According to one further example of the proposed method, the flat heating element can have a thickness of 1 mm to approximately 4 mm, in one example of 1 mm. Here the heating elements of the flat heating element can be disposed within the 1 mm to 4 mm total outer dimension, so that they do not enlarge the outer dimension of the foam mat. In addition, the softness or hardness, in particular compression hardness, of the foam mat can be set by the variable thickness.

In one further development of the method, the first foam material can be introduced by front foaming, in which the first foam material is directly connected with the carrier element in a material-bonded manner. The interior cladding part can thereby be manufactured in a particularly efficient manner.

According to one further development, the flat hating element can be inserted into the first tool side of the foaming tool, and the carrier element can be inserted into a second tool side of the foaming tool, in which the flat heating element is connected with the carrier element with the first foam material applied onto its first flat side by closing of the first and/or second tool side, i.e., by bringing together of the two tool sides. This makes possible a particularly simple manufacturing of the interior cladding part.

In one further development the carrier element can be provided with a notch for the guiding of an electrical line of the flat heating element, in which the electrical line is guided at least partially within the foaming tool, and during the foaming method a functional testing of the electrical line and/or of the flat heating element is performed. For example, an end facing away from the flat heating element can be connected with a functional testing device. e.g., be plugged together with this or similar, which is suitable for continuity testing or other functional testing. This can even be affected during the reaction of the foam material, e.g., exothermal reaction, and/or the foaming, curing, etc. of the foam material, whereby time can be saved in the manufacturing process.

In addition, a use is proposed of the interior cladding part manufactured according to the above-described method in one or more of the described further developments as a heatable armrest in a vehicle. Here the interior cladding part manufactured according to the method makes possible a high product quality that can also be achieved with a comparatively simply designed method, since no heating element or part thereof, such as, for example, heating elements, stand out on the interior cladding part.

Furthermore, a method for the manufacturing of an interior cladding part in at least two different examples. Here in a first example the interior cladding part is optionally heatable with a visible side and includes a flat heating element, and in a second example the interior cladding part is embodied non-heatable with a visible side. The method comprises the following steps. First it is determined whether the interior cladding part is to be manufactured or provided in the first or the second example. Furthermore a carrier element is provided with a notch for the optional guiding of an electrical line of the flat heating element. Here when it is determined that the interior cladding part is to be provided in the first example, the method is carried out with the following steps:
Arranging of the flat heating element as a foam mat in a foaming tool such that the flat heating element abuts, with a first flat side that is facing the visible side of the interior cladding part to be manufactured, against an inner surface of the foaming tool;
Introducing of a first foam material into the foaming tool on a second flat side, opposite the first flat side, of the flat heating element, such that the flat heating element is back-foamed only on the second flat side; in which the first foam material connects with the carrier element and the flat heating element.

However, when it is determined that the interior cladding part is to be provided in the second example, the method is carried out with the following steps:

Introducing of a first foam material into a foaming tool; in which the first foaming material connects with the carrier element, and in which the notch of the carrier element is foam-closed with the first foam material.

In other words, for both to-be-manufactured or manufacturable examples a uniformly formed carrier element is provided that is consequently a unitary part without variants. When the first, heatable example of the interior cladding part is to be manufactured, the above-described method is carried out in one or more of the described further developments, so that then with the unitary provided carrier element a heatable interior cladding part can be manufactured or provided. However, when the second, non-heatable example of the interior cladding part is to be manufactured, the same carrier element is indeed used, but the notch is simply foam-closed, whereby subsequent processes, such as, for example, a laminating of the carrier element back-foamed with the foam material, need not be modified with respect to the first example of the interior cladding part. The method thus makes possible a range of variants of the interior cladding part in which the carrier element need only be available in a single, unitary example, and the manufacturing process remains substantially the same, at least need not be modified in follow-up processes.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is an exploded perspective view of a heatable interior cladding part that can be manufactured with a method according to one example of the present disclosure;

FIG. 2 is a top view of a heatable interior cladding part that can be manufactured with a method according to one example of the present disclosure;

FIG. 3A is a schematic view of an arrangement of heating elements on, for example, a fleece material as is used in conventional methods for the manufacturing of heatable interior cladding parts;

FIG. 3B is a schematic view of an arrangement of heating elements that are embedded in a foam material for the forming of a foam mat, as is used in a method according to one example of the present disclosure of a method for the manufacturing of heatable interior cladding parts; and

FIG. 4 is a schematic view of a foaming tool with a flat heating element disposed therein, as is used in a method according to one example of the present disclosure of a method for the manufacturing of heatable interior cladding parts.

The Figures are merely schematic representations and only serve for the explaining of the present disclosure. Identical or functionally identical elements are provided with the same reference numbers throughout.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

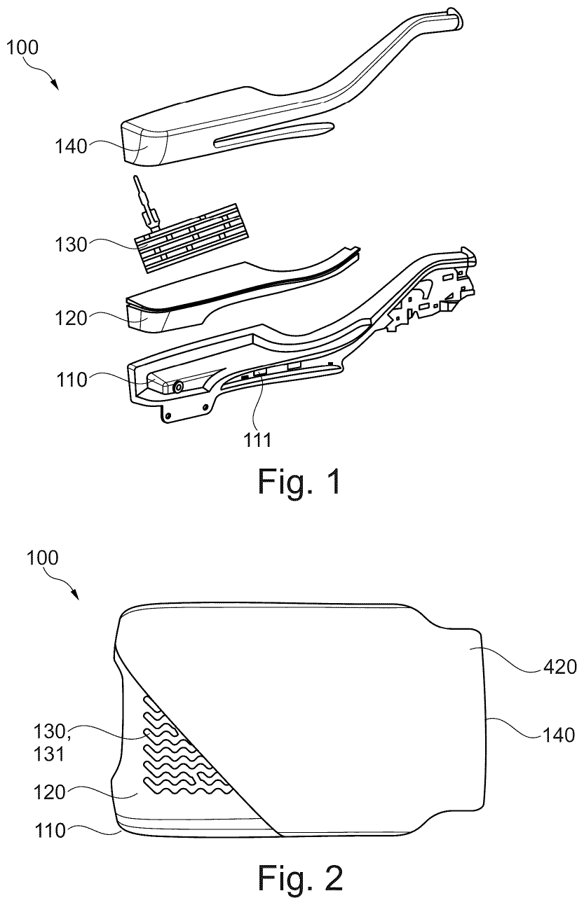

FIG. 1 shows, in an exploded view, a heatable interior cladding part 100 that can be manufactured with a method according to one example. For example, the interior cladding part 100 can be suitable as an armrest on a door cladding, a central console, or similar in a vehicle, airplane, or similar. The interior cladding part 100 has a visible side that in its use is facing the vehicle- or airplane-interior or an occupant.

As structure-conferring element, that is, base element, the interior cladding part 100 includes a carrier element 110, that can be manufactured, for example, from a plastic material, such as, for example, polycarbonarte (PC) or acrylonitrile-butadiene-styrene copolymer (ABS). For example, the carrier element 110 can be manufactured using an injection-molding process. The carrier element 110 can include one or more notches, for example, a material recess, a breakout, or similar, that is suitable for the guiding and/or through-guiding of an electrical line. In the exploded view according to FIG. 1, the carrier element 110 is the part farthest removed from the visible side of the interior cladding part 100, and thus represents the lowermost part thereof.

In addition, the interior cladding part 100 includes a foam material 120, i.e., a foam body, made of a foamed plastic material, e.g., polyurethane (PUR) or similar, which is connected with the carrier element 110, in one example, in a material-bonded manner, and in FIG. 1 is disposed above the carrier element 110. In this application the foam material 120 is also referred to as “first foam material.”

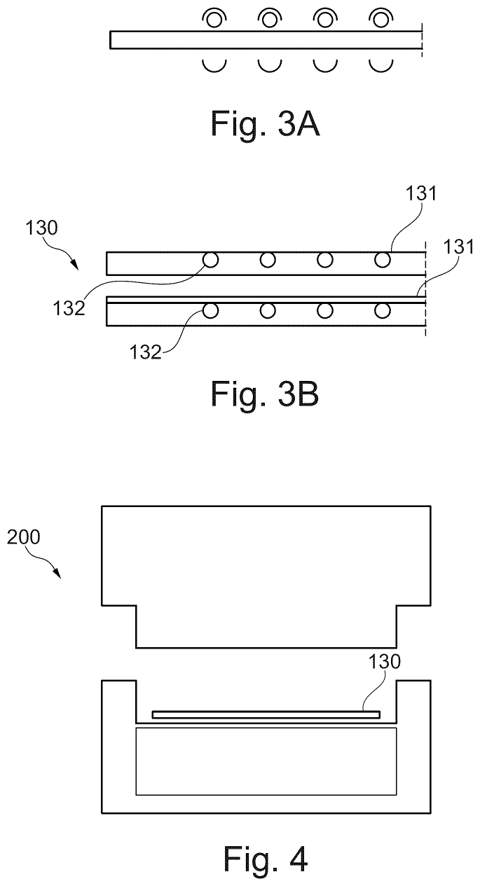

Furthermore, the interior cladding part 100 includes for its optional heating a flat heating element 130 that is configured as foam mat with a plate-shaped foam body 131 made of a foam material, e.g., a foamed polymer, with heating elements 132 (shown in FIG. 3B), for example, heating coils or similar, embedded therein, and can therefore also be referred to as foamed heating mat with embedded heating elements. The heating elements 132 are disposed flush with or recessed with respect to a flat side of the foam body 131 that is facing the visible side and in this application is also referred to as “first flat side.” The foam material has, for example, a greater softness or lesser hardness than, in particular, a fleece material. In this application the foam material of the flat heating element is also referred to as the “second foam material,” in contrast to the first foam material 120. It is noted that the first and the second foam material can be different, wherein an identical material pairing is also conceivable, provided both foam materials can be connected with each other or adhere with each other. The flat heating element 130 includes two opposing, at least substantially flat surfaces without elevation, i.e., with heating elements 130 embedded in instead of placed on the foam material. In FIG. 1 it is indicated that the flat heating element 130 is disposed above the foam material 120, in which the flat heating element 130 is connected, in one example, in a material-bonded manner, with the foam material 120, for example, by front-foaming. In other words, the flat heating element 130 is back-foamed with the foam material 120. The flat heating element 130 has a thickness of 1 mm to 4 mm, such as 1 mm.

The interior cladding part 100 also includes a decorative material 140, such as, for example, a leather, artificial leather, or similar, that in principle forms the visible side of the interior cladding part or is disposed there. Accordingly, the decorative material 140 is the topmost element of the construction depicted in FIG. 1, i.e., the decorative material 140 is disposed above the flat heating element 130. From this it is inferable that the flat heating element 130 abuts directly against the decorative material 140, i.e., no further element is disposed therebetween, such as, for example, a cut foam, which in conventional methods serves to inhibit standing out of any heating elements, such as, for example, heating coils placed on a fleece.

FIG. 2 shows the interior cladding part 100 in a plan view, in which purely for illustrative purposes the decorative material 140 is partially omitted in order to make clear that the flat heating element 130 abuts directly against the decorative material 140 and the heating elements 132, e.g., heating coils or similar, do not protrude from their foam body 131.

Based on FIGS. 3A and 3B, it is further made clear that with—as shown in FIG. 3A-a conventional arrangement with a fleece and heating coils disposed thereon, the heating coils would stand out in the decorative material, i.e., on the visible side of the interior cladding part 100. Due to the foam mat used in the interior cladding part 100—as shown in FIG. 3B—the heating elements 132, e.g., heating coils or similar, are embedded in the foam material or the foam body 131, so that the heating coils are not disposed on top, and they stand out at least less or not at all through the decorative material 140. As indicated in FIG. 3B, the heating elements 132 are at least embedded in the foam material of the flat heating element 130, or arranged in a sandwich-type manner.

Based on in particular FIG. 4, which shows in a rough schematic manner a foaming tool 200 with flat heating element 130 disposed therein, a method for the manufacturing of the interior cladding part 100 shall now be described.

First the carrier element 110 is provided which, as described above, can be produced, for example, from a plastic material in an injection-molding method. Furthermore the flat heating element 130 is arranged as a foam mat in the foaming tool 200 such that the flat heating element 130 abuts with a first flat side, which is facing the visible side of the interior cladding part 100 to be manufactured, against an inner surface of the foaming tool 200. Then the first foam material 120 is in the foaming tool 200 on a second flat side, opposite the first flat side, of the flat heating element 130 such that the flat heating element 130 is back-foamed only on the second flat side. Here the first foam material 120 connects with the carrier element 110 and the flat heating element 130. The flat heating element 130 is connected with the first foam material 120 applied onto the first flat side by closing the first tool side and the second tool side with the carrier element 110.

The above-described method also makes possible the manufacturing of the interior cladding part 100 in at least two different examples. In a first example, the interior cladding part 100 is heatable and includes the flat heating element 130. In a second example, the interior cladding part 100 is non-heatable, without the flat heating element 130.

It is first determined whether the interior cladding part 100 is to be manufactured in the first or the second example. This can be achieved, for example, by evaluating the specification—or order—data, also automatically by computer-implemented evaluation. First the carrier element 110 is provided with a notch 111 (see FIG. 1) for the optional guiding of an electrical line of the flat heating element 130, and specifically as unitary part independent of the determined example of the interior cladding part 100. During the introduction of the first foam material 120 into the foaming tool 200 a functional testing of at least one of the electrical line or the flat heating element 130 is carried out. Here with determination that the interior cladding part 100 is to be provided in the first example, the method is carried out such that the flat heating element 130 is disposed as foam mat in the foaming tool 200 such that the flat heating element 130 abuts with a first flat side, which is facing the visible side of the interior cladding part 100 to be manufactured, against an inner surface of the foaming tool 200 (the bottom side of the foaming tool 200 according to FIG. 4). Then the first foam material 120 is introduced into the foaming tool 200 on a second flat side, opposite the first flat side, of the flat heating element 130 such that the flat heating element 130 is back-foamed only on the second flat side, wherein the first foam material 120 connects with the carrier element 110 and the flat heating element 130. However, when it is determined that the interior cladding part 100 is to be provided in the second example, the method is carried out such that the first foam material 120 is introduced in the foaming tool 200, and specifically without the flat heating element 130 being used at all and inserted into the foaming tool 200. Then the first foam material 120 connects with the carrier element 110; the notch 111 of the carrier element 110 is foam-closed with the first foam material 120.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for manufacturing an interior cladding part with a visible side and a flat heating element, the method comprising:
providing a carrier element,
arranging the flat heating element as a foam mat in a foaming tool such that the flat heating element abuts with a first flat side, and the first flat side is facing the visible side of the interior cladding part to be manufactured, and the flat heating element is against an interior surface of the foaming tool;
introducing a first foam material into the foaming tool on a second flat side of the flat heating element, the second flat side is opposite the first flat side, such that the flat heating element is back-foamed on the second flat side, the flat heating element is inserted into a first tool side of the foaming tool, the carrier element is inserted into a second tool side of the foaming tool, and the flat heating element is connected with the first foam material applied onto the first flat side by closing the first tool side and the second tool side with the carrier element.

2. The method according to claim 1, wherein the flat heating element is clad with a decorative material, and the first flat side of the flat heating element abuts directly against the decorative material that forms the visible side of the interior cladding part.

3. The method according to claim 1, wherein the flat heating element is configured as a foam mat with heating elements embedded in a second foam material.

4. The method according to claim 3, wherein the heating elements of the flat heating element are arranged flush with respect to the first flat side.

5. The method according to claim 3, wherein the heating elements of the flat heating element are recessed with respect to the first flat side.

6. The method according to claim 1, wherein the flat heating element has a thickness of 1 mm to 4 mm.

7. The method according to claim 6, wherein the flat heating element has a thickness of 1 mm.

8. The method according to claim 1, wherein the first foam material is introduced by front-foaming, the first foam material is directly connected with the carrier element in a material-bonded manner.

9. The method according to claim 1, wherein the carrier element includes a notch for guiding an electrical line of the flat heating element, the electrical line is guided within the foaming tool, and during the introducing of the first foam material into the foaming tool a functional testing of at least one of the electrical line and the flat heating element is carried out.

10. An interior cladding part manufactured according to the method of claim 1, and the interior cladding part comprises a heatable armrest in a vehicle.

11. A method for manufacturing an interior cladding part, comprising:
providing of a uniform carrier element with a notch for a selective guiding of an electrical line of a flat heating element,
arranging of the flat heating element as a foam mat in a foaming tool such that the flat heating element abuts with a first flat side, which is facing a visible side of the interior cladding part to be manufactured, and the flat heating element is against an inner surface of the foaming tool, introducing of a first foam material into the foaming tool on a second flat side, opposite the first flat side, of the flat heating element such that the flat heating element is back-foamed only on the second flat side, wherein the flat heating element is inserted into a first tool side of the foaming tool, the carrier element is inserted into a second tool side of the foaming tool, and the flat heating element is connected with the first foam material applied onto its first flat side by closing of the first and second tool side with the carrier element; or
introducing of the first foam material into the foaming tool, wherein the first foam material is connected with the carrier element, and wherein the notch of the carrier element is foam-closed with the first foam material.

12. The method of claim 11, wherein the method comprises arranging of the flat heating element as foam mat in the foaming tool, and the visible side of the interior cladding part includes a flat heating element.

13. The method of claim 11, wherein the method comprises the introducing of the first foam material into the foaming tool and a visible layer of the interior cladding part is unheatable.
